(19) United States
(12) Patent Application Publication
(10) Pub. No.: US 2004/0223085 A1
(43) Pub. Date: Nov. 11, 2004

(54) Device for removing interference signal with different characteristic and method for removing thereof

(75) Inventor: Jung-won Kwak, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/756,464

(22) Filed: Jan. 14, 2004

(30) Foreign Application Priority Data
May 9, 2003 (KR) 2003-29254

(51) Int. Cl. H04N 5/21

(52) U.S. Cl. 348/607

(57) ABSTRACT

A device for removing an interference signal with a different characteristic included in input signals and an interference signal removing method are disclosed. The device for removing an interference signal comprises an IIR notch filter for generating a notch to remove the signal with a different characteristic included in the input signals, a frequency tracking unit for tracking a frequency in the frequency domain for the signal with a different characteristic included in the input signals to provide a position value of the notch, and a power ratio calculation unit for calculating a power ratio of the signal different from the input signals on the characteristic and providing a depth value of the notch set in correspondence with the calculated power ratio, wherein the IIR notch filter removes the signal with a different characteristic using the position value and the depth value. Accordingly, the signal with a different characteristic included in the input signals can be correctly removed.

### CROSS-REFERENCE TO RELATED APPLICATIONS

This application claims the benefit of Korean Patent Application No. 2003-29254 filed May 9, 2003, in the Korean Intellectual Property Office, the disclosure of which is incorporated herein by reference.

### BACKGROUND

1. Field of the Invention

The present invention relates to a digital receiving device, and more particularly to a device for removing an interference signal with a different characteristic included in input signals and a method for removing thereof.

2. Description of the Related Art

In a general terrestrial HDTV receiver, channel interference arises due to NTSC TV signals, which are analog signals using the same 6 MHz frequency band as used by HDTV signals. Therefore, a comb-filter has been used to remove the NTSC TV signals in the same frequency band generating the channel interference of an HDTV receiving terminal.

FIG. 1 is a spectrum diagram of HDTV signals as input signals and analog NTSC TV signals in the frequency band of 6 MHz. As shown in FIG. 1, a comb-filter 10 of FIG. 2 is used to remove three carrier signals, V (Visual), C (Chrominance), and A (Aural), which are NTSC TV signals.

The comb-filter 10 is a linear feed-forward filter that has one tap, in which input signals are reversed and delayed by a feed-forward delayer 3 and then provided to an adder 7.

The delay coefficient of the delayer 3 of the comb-filter 10 provides null signals having a predetermined cycle to the comb-filter 10. That is to say, the delay coefficient of the delayer 3 is adjusted to locate three carrier signals, V, C and A, which are NTSC TV signals as shown in FIG. 1, in almost the same positions as the null signals.

Referring to the spectrum diagram shown in FIG. 1, a symbol rate is adjusted to 13.3125 MHz in order to generate null signals at frequencies of V, C and A carrier signals as shown in FIG. 3, and for this, the delay coefficient of the delayer 3 is set as 12. Namely, the number of the null signals generated within the band of 6 MHz is equivalent to a value calculated by dividing the symbol rate by the delay coefficient of the delayer 3. Consequently, the interval between the null signals is 896.85 KHz and 7 null signals exist within the channel band of 6 MHz.

As shown in FIG. 3, the carrier signal V (Visual) is located near to a null signal the second from an end of a lower band and the carrier signal C (Chrominance) is located almost congruously with a sixth null signal. And the carrier signal A (Aural) is located near to a seventh null signal. In other words, the location of null signals generated by the conventional comb-filter and the location of the three carrier signals of the NTSC TV signals, are made coincident with each other, thus removing the NTSC TV signals.

However, there are several problems in removing the analog NTSC TV signals using the conventional comb-filter 10.

First of all, it is impossible to adjust the three carrier signals (V, C and A) of the NTSC TV signals correctly to the position of the null signals of the comb filter 10. As shown in FIG. 3, the carrier signal C is almost correctly adjusted to the sixth null signal, while the other carrier signals, V and A, have some offsets. Therefore, the NTSC TV signals are not completely removed and this has a bad influence upon HDTV signals.

Furthermore, original HDTV signals are distorted due to regular null signals of the comb-filter. That is to say, other null signals except the null signals for removing three carrier signals are not necessary and they cause the HDTV signals to be distorted. Accordingly, a trellis decoder is required to recover the distortion of the HDTV signals, causing a problem of a complicated decoder.

### SUMMARY

To solve the above-mentioned problems, it is an aspect of the present invention to provide a device for removing an interference signal with a different characteristic and an interference signal removing method thereof.

To achieve the above aspect and/or other features of the present invention, there is provided a device for removing an interference signal, comprising: an IIR notch filter for generating a notch to remove a signal with a different characteristic included in input signals; a frequency tracking unit for tracking a frequency in the frequency domain for the signal with a different characteristic included in the input signals to provide a position value of the notch; and a power ratio calculation unit for calculating a power ratio of the signal different from the input signals on the characteristic and providing a depth value of the notch set correspondingly to the calculated power ratio, wherein the IIR notch filter generates the notch corresponding to the signal with a different characteristic using the position value and the depth value.

Preferably, the frequency tracking unit uses an ALE (Adaptive Line Enhancer) algorithm.

The power ratio calculation unit provides the IIR notch filter with the depth value and width value of the notch set correspondingly to the calculated power ratio.

A transfer function, H(z), of the IIR notch filter is defined as follows:

$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$

Here, k₀ is a position value, k₁ is a depth value, α is a width value, and z is a delay coefficient.

An exemplary embodiment of a method for removing a signal with a different characteristic in accordance with the present invention, comprises: a position value acquisition step for tracking a frequency in the frequency domain for a signal with a different characteristic included in input signals to acquire a position value of a notch; a depth value acquisition step for calculating a power ratio of the signal different from the input signals on the characteristic and acquiring a depth value of the notch set correspondingly to the power ratio; and a filtering step for generating the notch corresponding to the signal with a different characteristic using the position value and the depth value to remove the signal with a different characteristic.

Preferably, an ALE (Adaptive Line Enhancer) algorithm is used in the position value acquisition step.

The depth value acquisition step acquires the depth value and width value of the notch, which are set corresponding to the calculated power ratio. The filtering step removes the signal with a different characteristic using the position value, the depth value and the width value.

Accordingly, the signal with a different characteristic existing in the same frequency band as the input signals can be correctly filtered.

### BRIEF DESCRIPTION OF THE DRAWINGS

FIG. 1 is a spectrum diagram of HDTV signals and NTSC TV signals existing in the same frequency band of 6 HMz;

FIG. 2 is a configuration diagram of a conventional comb-filter;

FIG. 3 is a diagram illustrating NTSC TV signals applied to null signals generated correspondingly to the delay coefficient of a delayer of the comb-filter shown in FIG. 2;

FIG. 4 is a block diagram of a device for removing an interference signal in accordance with a exemplary embodiment of the present invention;

FIG. 5 is a diagram of an IIR notch filter of a device for removing an interference signal in accordance with the present invention;

FIG. 6 is a diagram illustrating a frequency tracking unit of a device for removing an interference signal in accordance with the present invention;

FIG. 7 is a block diagram of a device for removing an interference signal in accordance with another exemplary embodiment of the present invention;

FIG. 8 is a block diagram of a device for removing an interference signal in accordance with still another exemplary embodiment of the present invention; and

FIG. 9 is a diagram illustrating the steps of removing a signal with a different characteristic by a device for removing an interference signal in accordance with the present invention.

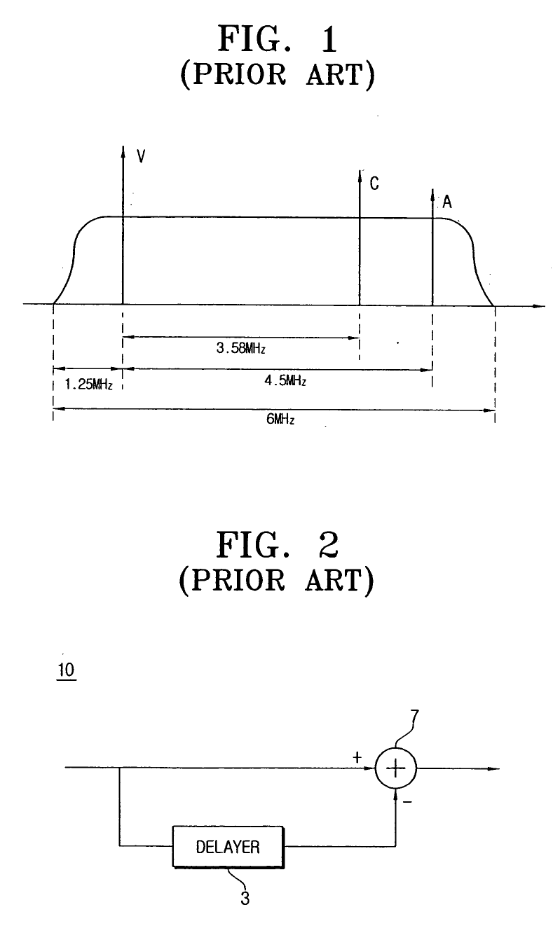

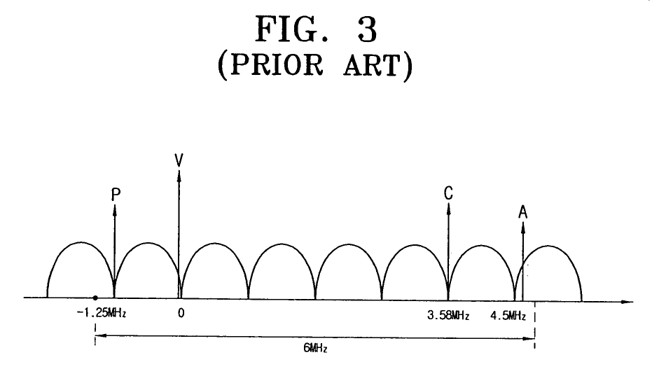

### DESCRIPTION OF THE EXEMPLARY EMBODIMENTS

Exemplary embodiments of the present invention will now be described with reference to the accompanying drawings.

A device for removing an interference signal in accordance with the present invention comprises an IIR notch filter for generating a notch to remove a signal with a different characteristic included in input signals, a frequency tracking unit for tracking a frequency in the frequency domain for the signal with a different characteristic included in the input signals, and a power ratio calculation unit for calculating a power ratio of the signal different from the input signals on the characteristic and providing a depth value and a width value of the notch set correspondingly to the calculated power ratio. The IIR notch filter decides the position of the notch using the frequency of the signal with a different characteristic tracked by the frequency tracking unit, and generates the notch adaptive to the signal to be filtered according to the depth value and the width value provided by the power ratio calculation unit, and then filters the notch.

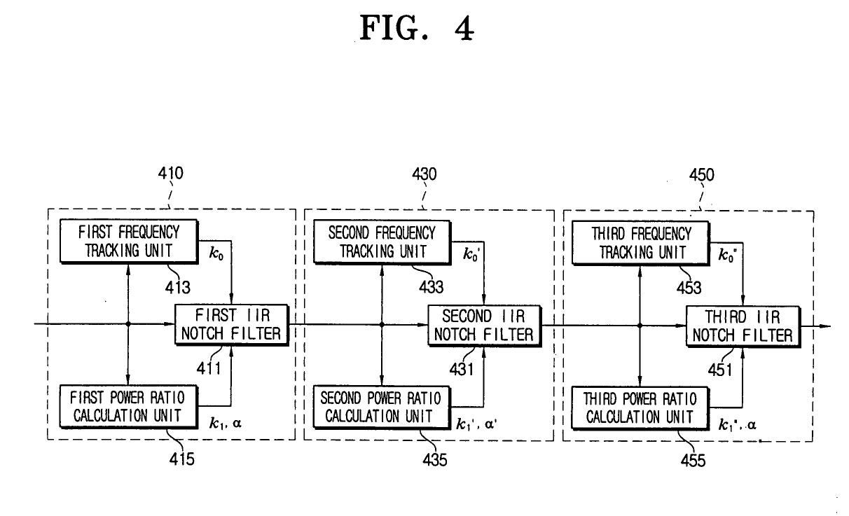

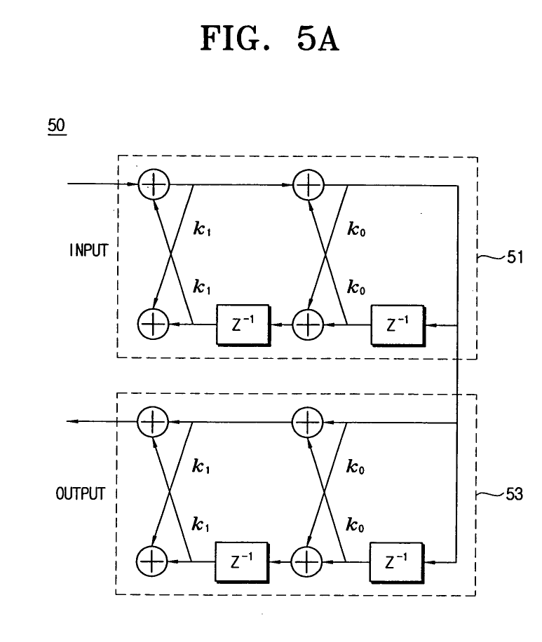

FIG. 4 is a detailed block diagram of a device for removing analog interference signals with different characteristics included in the input signals, in accordance with an exemplary embodiment of the present invention.

The device for removing interference signals includes a plurality of filtering units 410, 430 and 450 corresponding to a plurality of analog signals included in the input signals.

As the configurations of the first, the second and the third filtering units 410, 430 and 450 are the same, hereinafter, the first filtering unit 410 will be described in detail, representative of the other filtering units.

The first filtering unit 410 includes a first IIR notch filter 411, a first frequency tracking unit 413, and a first power ratio calculation unit 415.

The first IIR notch filter 411 generates a notch, which has a value k₀ corresponding to a predetermined frequency, and a predetermined depth k₁ and width α, in order to remove a first carrier signal included in the input signals.

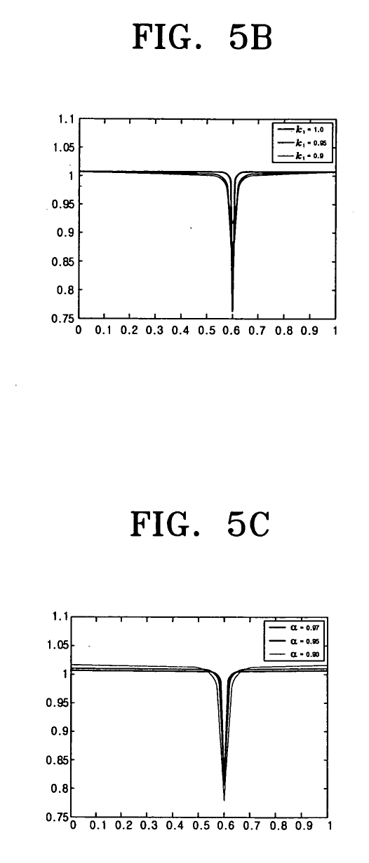

FIGS. 5A-5C are diagrams of an IIR notch filter 50 in accordance with the present invention. FIG. 5A is a diagram illustrating the structure of the IIR notch filter 50. The IIR notch filter 50 is configured to comprise an all pole lattice filter 51 and an all zero lattice filter 53 connected in cascade. A transfer function, H(z), of the IIR notch filter 50 is expressed as the following Formula 1:

$$H ( z ) = \frac{N ( z )}{D ( z )} = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}} \qquad [ Formula 1 ]$$

Here, k₀ is a value corresponding to a frequency ω₀ where the notch is located and defined as the equation, k₀=−cosω₀. k₁ is a value corresponding to the depth of the notch, while α is a value corresponding to the width of the notch.

FIG. 5B represents a diagram of an amplitude response characteristic, and FIG. 5C represents a diagram of an amplitude response characteristic corresponding to the width of the notch. For example, in a case where k₀=30 as shown in FIG. 5A, the bigger the k₁ becomes, the bigger the depth of the notch would get. As shown in FIG. 5B, the smaller α becomes, the smaller the width of the notch would get.

That is to say, the first IIR notch filter 411 obtains k₀(=−cosω₀) by the frequency ω₀ provided from the first frequency tracking unit 413, and obtains k₁ and α from the first power ratio calculation unit 415. Then, the first IIR notch filter 411 generates the notch corresponding to k₁ and a at the frequency where a first carrier signal with a different characteristic included in the input signals is located, thereby removing the first carrier signal.

The first frequency tracking unit 413 tracks the frequency ω₀ on the frequency domain for the first carrier signal in the input signals using a frequency tracking algorithm, such as ALE (Adaptive Line Enhancer), LMS, etc.

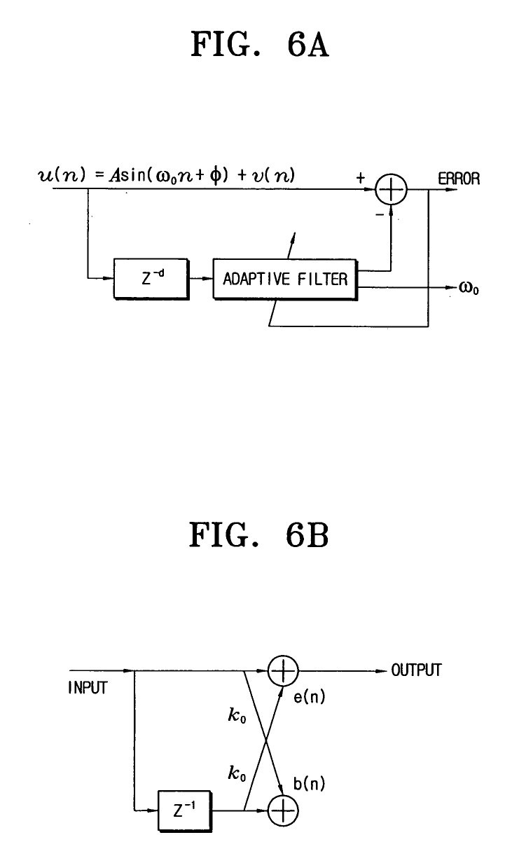

FIG. 6 is a view for showing an example of the ALE (Adaptive Line Enhancer) algorithm applied to the first frequency tracking unit 413. An adaptive filter is used in FIG. 6A. If a signal v(n) with a different characteristic is added to input signals u(n)=Asin(ω₀n+φ), the frequency ω₀ on the frequency domain is tracked for the signal v(n) with a different characteristic by the adaptive filter.

FIG. 6B is a view for showing an example using an adaptive lattice predictor, or all zero filter. The all zero filter decides its coefficient k₀ to minimize the sum of each square of a forward prediction error e(n) and a backward prediction error b(n). The decided filter coefficient k₀ is the most stable when it satisfies the expression, |k₀|<1. Here, the filter coefficient k₀ is defined as the equation, k₀=−cosω₀, thus the frequency ω₀ is tracked.

The first power ratio calculation unit 415 calculates an ACSR (Analog TV Carrier to DTV Signal power Ratio) when an SNR (Signal-to-Noise Ratio) of input signals comes to the maximum. The SNR is defined by the following Formula 2:

$$\begin{matrix}SNR = \frac{E [ {p}^{2} ( n ) ]}{E [ {( y ( n ) - p ( n ) )}^{2} ]} \\ = \frac{1}{( 1 + {σ}^{2} ) \frac{1 + {k}_{1}^{2}}{1 - {α}^{2} {k}_{1}^{2}} + ACSR \frac{{( 1 - {k}_{1} )}^{2}}{{( 1 - α {k}_{1} )}^{2}} - 1}\end{matrix} \qquad [ Formula 2 ]$$

Here, p(n) is a digital signal, y(n) is an input signal of a receiver, σ is standard deviation, k₁ is a depth, and α is a width.

The first power ratio calculation unit 415 provides the first IIR notch filter 411 with the depth k₁ and width α of the notch, which are set corresponding to the calculated ACSR.

Accordingly, the first IIR notch filter 411 generates the notch with the depth k₁ and with the width α, at the frequency ω₀ where the first carrier signal is located to remove the first carrier signal.

The first carrier signal included in the input signals is removed as such. Then, the input signals from which the first carrier signal is removed are inputted to the second filtering unit 430 and the third filtering unit 450, to sequentially remove a second carrier signal and a third carrier signal.

Surely, a preset position value may be used instead of the frequency tracking unit, and a preset depth value and a width value may be used instead of the power ratio calculation unit.

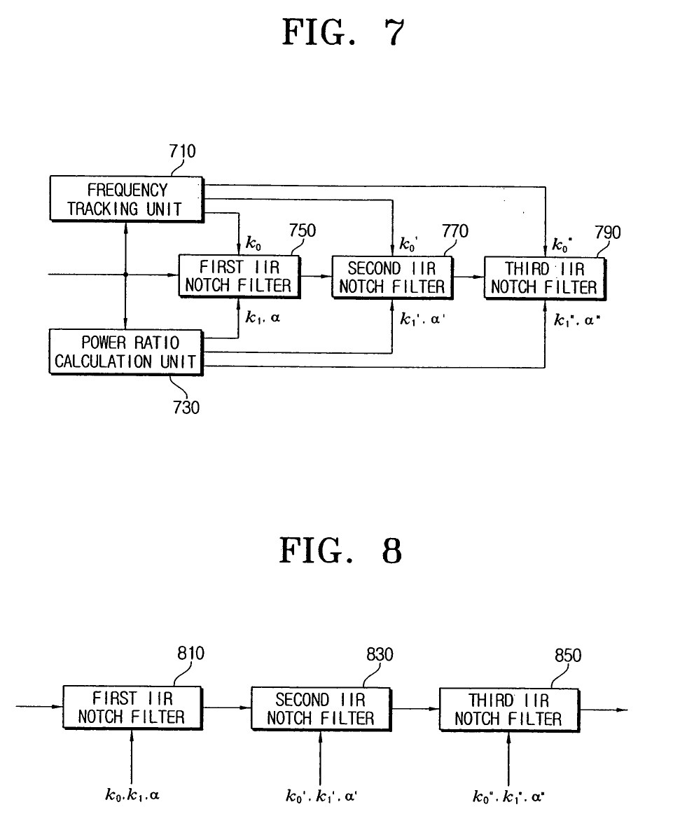

FIG. 7 is a block diagram of a device for removing an interference signal in accordance with another exemplary embodiment of the present invention.

A device for removing signal interference comprises a frequency tracking unit 710 for tracking a frequency in the frequency domain for one analog signal among a plurality of analog signals included in the input signals, a power ratio calculation unit 730 for calculating a power ratio for one analog signal tracked in the frequency tracking unit 710, and a plurality of IIR notch filters 750, 770 and 790 for removing plural analog signals included in the input signals on the basis of k₀, k₁, and a acquired in the frequency tracking unit 710 and the power ratio calculation unit 730.

The frequency tracking unit 710 tracks a frequency in the frequency domain for one analog signal among a plurality of analog signals included in the input signals by using a frequency tracking algorithm, e.g., the adaptive filter of FIG. 5A. It is preferable to track a frequency ω₀ of a first carrier signal, that is an analog signal existing in the lowest band of the frequency domain. Using the tracked frequency ω₀, k₀ (k₀=−cosω₀) is obtained and provided to the first IIR notch filter 750.

In addition, the first frequency tracking unit 710 adds predetermined values, a and b, to the tracked frequency ω₀ of the first carrier signal, for provision to the second and third IIR notch filters 770 and 790. Here, the predetermined values, a and b, correspond to the frequency interval in the frequency domain of second and third carrier signals for the first carrier signal. That is to say, a frequency ω₀′=ω₀+a that adds the value of “a” corresponding to the frequency interval of the first carrier signal and the second carrier signal is provided to the second IIR notch filter 770, while a frequency ω₀″=ω₀+b that adds the value of “b” corresponding to the frequency interval of the first carrier signal and the third carrier signal is provided to the third IIR notch filter 790.

In the meantime, the power ratio calculation unit 730 calculates a first power ratio (ACSR) for the first carrier signal and a digital signal when an SNR of the input signals comes to the maximum. k₁ and α are set in correspondence with the calculated first ACSR are provided to the first IIR notch filter 750.

Also, the power calculation unit 730 calculates a second power ratio and a third power ratio for the second and third carrier signals by adding predetermined values, c and d, to the first power ratio calculated for the first carrier signal. Here, the predetermined values, c and d, correspond to the percentage of each power ratio of the second and third carrier signals for the first power ratio of the first carrier signal. The power ratio calculation unit 730 sequentially provides each k₁′, k₁″ and α′, α″ set correspondingly to the second and third power ratios calculated as above to the second and third IIR notch filters 770 and 790.

Accordingly, the first IIR notch filter 750 removes the first carrier signal based on the k₀, k₁ and a for the first carrier signal provided by the frequency tracking unit 710 and the power ratio calculation unit 730. Next, the second IIR notch filter 770 removes the second carrier signal based on the k₀′, k₁′ and α′ for the second carrier signal provided by the frequency tracking unit 710 and the power ratio calculation unit 730, and the third IIR notch filter 790 removes the third carrier signal based on the k₀″, k₁″ and α″ for the third carrier signal provided by the frequency tracking unit 710 and the power ratio calculation unit 730.

FIG. 8 is a block diagram of a device for removing an interference signal in accordance with still another exemplary embodiment of the present invention.

A device for removing an interference signal includes a plurality of IIR notch filters 810, 830 and 850 that remove a plurality of analog carrier signals included in the input signals. The IIR notch filters 810, 830 and 850 remove the analog signals by setting k₀, k₁ and a corresponding to the analog signals therein, or using k₀, k₁ and a stored in a ROM in advance.

That is, the first IIR notch filter 810 removes a first carrier signal based on k₀, k₁ and α, which are set in correspondence with the first carrier signal, the second IIR notch filter 830 removes a second carrier signal based on k₀′, k₁′ and α′, which are set in correspondence with the second carrier signal, and the third IIR notch filter 850 removes a third carrier signal based on k₀″, k₁″ and α″, which are set in correspondence with the third carrier signal.

Although the above various embodiments explain cases where both of a depth value k₁ and a width value α of a notch are provided to an IIR notch filter to remove a signal with a different characteristic included in input signals, only k₁, that is, the depth of the notch, may be provided to the IIR notch filter as operation characteristics of the notch filter are more related to the notch depth rather than the notch width.

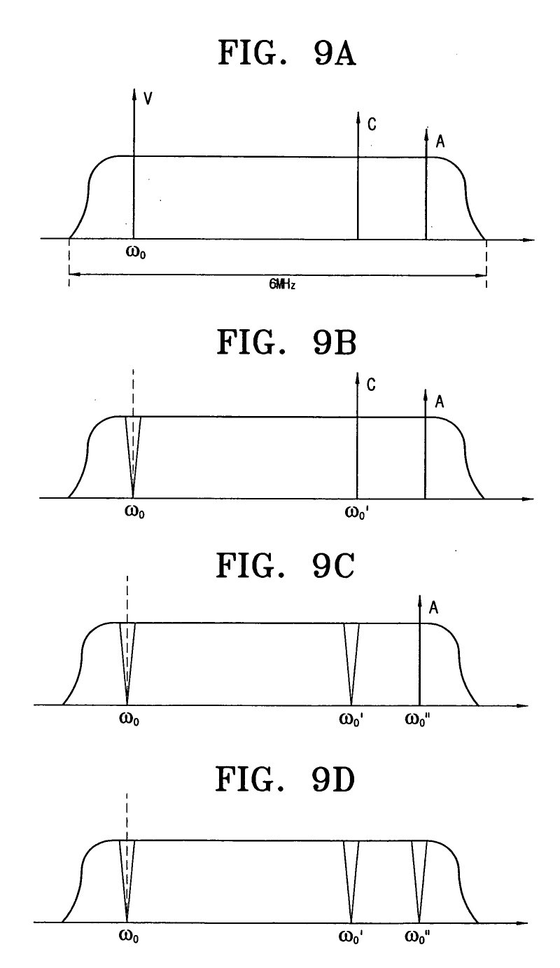

FIGS. 9A-9D are diagrams illustrating the process of removing an analog carrier signal included in input signals by a device for removing an interference signal in accordance with the present invention, which will be explained in more detail by referring to FIG. 4.

FIG. 9A shows a spectrum illustrating the coexistence of HDTV signals and NTSC TV signals in the frequency band of 6 MHz.

Input signals having a spectrum as shown in FIG. 9A are inputted to the first filtering unit 410. The first frequency tracking unit 413 tracks a first frequency ω₀ of a first carrier signal V (Visual) among NTSC TV signals included in the input signals. k₀, which corresponds to the tracked first frequency ω₀, is obtained and provided to the first IIR notch filter 411. The first power ratio calculation unit 415 calculates a first power ratio (ACSR) of the first carrier signal V for the input signals, and provides the first IIR notch filter 411 with k₁ and α, which are set in correspondence with the calculated first power ratio (ACSR).

The first IIR notch filter 411 removes the first carrier signal V using k₀, k₁ and α corresponding to the inputted first carrier signal, as shown in FIG. 9B.

The input signals from which the first carrier signal V is removed, as shown in FIG. 9B, are inputted to the second filter part 430.

The second frequency tracking unit 433 of the second filtering unit 430 tracks a second frequency ω₀′ of a second carrier signal C (Chrominance) among the NTSC TV signals included in the input signals. k₀′, which corresponds to the tracked second frequency ω₀′, is obtained and provided to the second IIR notch filter 431. The second power ratio calculation unit 435 calculates a second power ratio (ACSR) of the second carrier signal C for the input signals, and provides the second IIR notch filter 431 with k₁′ and α′ set correspondingly to the calculated second power ratio (ACSR).

The second IIR notch filter 431 removes the second carrier signal C using k₀′, k₁′ and α′ corresponding to the inputted second carrier signal, as shown in FIG. 9C.

The input signals from which the first and the second carrier signals V and C are removed, as shown in FIG. 9C, are inputted to the third filter part 450.

The third frequency tracking unit 453 of the third filtering unit 450 tracks a third frequency ω₀″ of a third carrier signal A (Aural) among the NTSC TV signals included in the input signals. k₀″, which corresponds to the tracked third frequency ω₀″, is obtained and provided to the third IIR notch filter 451. The third power ratio calculation unit 455 calculates a third power ratio (ACSR) of the third carrier signal (A) for the input signals, and provides the third IIR notch filter 451 with k₁″ and α″, which are set in correspondence with the calculated third power ratio (ACSR).

The third IIR notch filter 451 removes the third carrier signal A using k₀″, k₁″ and α″ corresponding to the input third carrier signal, as shown in FIG. 9D.

Thus, NTSC TV signals included in HDTV signals can be correctly filtered, by generating a notch using an IIR notch filter, the notch being adaptive to the depth and width thereof according to a power ratio of analog signals and digital signals at the frequency where the NTSC TV signals exist.

According to the present invention constructed as such, there are advantages. First, analog signals included in digital signals can be correctly removed using the frequencies and power ratios of the analog signals existing in the same frequency band as the digital signals. Second, distortion of the digital signals can be prevented by correctly removing the analog signals.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device for removing an interference signal, comprising:
an IIR notch filter configured to generate a notch to remove a signal with a different characteristic included in input signals;
a frequency tracking unit configured to track a frequency in the frequency domain for the signal with a different characteristic included in the input signals to provide a position value of the notch; and
a power ratio calculation unit configured to calculate a power ratio of the signal with a different characteristic included in the input signals and providing a depth value of the notch, which is set in correspondence with the calculated power ratio,
wherein the IIR notch filter generates the notch corresponding to the signal with a different characteristic using the position value and the depth value.

2. The device according to claim 1, wherein the frequency tracking unit uses an ALE (Adaptive Line Enhancer) algorithm.

3. The device according to claim 1, wherein the power ratio calculation unit provides the IIR notch filter with the depth value and width value of the notch, which are set in correspondence with the calculated power ratio.

4. The device according to claim 3, wherein at least one of the position value, the depth value and the width value is a preset value.

5. The device according to claim 1, wherein the transfer function, H(z), of the IIR notch filter is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where, k₀ is a position value, k₁ is a depth value, α is a width value, and z is a delay coefficient.

6. A method for removing a signal with a different characteristic, comprising:
tracking a frequency in the frequency domain for a signal with a different characteristic included in input signals to acquire a position value of a notch;
calculating a power ratio of the signal with a different characteristic included in the input signals and acquiring a depth value of the notch which is set in correspondence with the power ratio; and
filtering the input signals by generating the notch corresponding to the signal with a different characteristic using the position value and the depth value to remove the signal with a different characteristic.

7. The method according to claim 6, wherein an ALE (Adaptive Line Enhancer) algorithm is used in the tracking operation.

8. The method according to claim 6, wherein the depth value and a width value of the notch which are set in correspondence with the calculated power ratio are acquired, and the signal with a different characteristic is removed using the position value, the depth value and the width value.

9. The method according to claim 8, wherein at least one of the position value, the depth value and the width value is a preset value.

10. The method according to claim 6, wherein the transfer function, H(z), in the filtering operation is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where k₀ is a position value, k₁ is a depth value, α is a width value, and z is a delay coefficient.

11. A device for removing an interference signal, comprising:
a first filtering unit comprising:
a first frequency tracking unit configured to track a frequency in the frequency domain for a first signal with a different characteristic included in input signals to provide a first position value,
a first power ratio calculation unit configured to calculate a first power ratio of the first signal with a different characteristic and providing a first depth value of the notch set in correspondence with the calculated first power ratio, and
a first IIR notch filter configured to remove the first signal with a different characteristic based on the first position value and the first depth value;
a second filtering unit comprising:
a second frequency tracking unit configured to track a frequency in the frequency domain for a second signal with a different characteristic included in the input signals to provide a second position value,
a second power ratio calculation unit configured to calculate a second power ratio of the second signal with a different characteristic and providing a second depth value set correspondingly to the calculated second power ratio, and
a second IIR notch filter configure to remove the second signal with a different characteristic based on the second position value and the second depth value; and
a third filtering unit comprising:
a third frequency tracking unit configured to track a frequency in the frequency domain for a third signal with a different characteristic included in the input signals to provide a third position value,
a third power ratio calculation unit configured to calculate a third power ratio of the third signal with a different characteristic and providing a third depth value set in correspondence with the calculated third power ratio, and
a third IIR notch filter configured to remove the third signal with a different characteristic based on the third position value and the third depth value.

12. The device according to claim 11, wherein each frequency tracking unit uses an ALE (Adaptive Line Enhancer) algorithm.

13. The device according to claim 11, wherein each power ratio calculation unit provides each IIR notch filter with the depth value and width value of the notch set in correspondence with the calculated power ratio.

14. The device according to claim 13, wherein at least one of each position value, depth value and width value is a preset value.

15. The device according to claim 11, wherein the transfer function, H(z), of each IIR notch filter is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where k₀ is a position value, k₁ is a depth value, α is a width value, and z is a delay coefficient.

16. A method for removing an interference signal, comprising:
removing a first signal with a different characteristic, using a first position value acquired by tracking a frequency in the frequency domain for the first signal with a different characteristic included in input signals and a first depth value of the notch set in correspondence with a first power ratio calculated for the first signal with a different characteristic; and
removing a second signal with a different characteristic, using a second position value acquired by tracking a frequency in the frequency domain for the second signal with a different characteristic included in the input signals and a second depth value of the notch set in correspondence with a second power ratio calculated for the second signal with a different characteristic.

17. The method according to claim 16, wherein each filtering step acquires each position value using an ALE (Adaptive Line Enhancer) algorithm.

18. The method according to claim 16, wherein each filtering step removes the respective signal with a different characteristic using the position value, the depth value, and the width value of the notch preset in correspondence with the power ratio calculated for the respective signal with a different characteristic.

19. The method according to claim 18, wherein the respective position values, depth values and width values are preset values.

20. The method according to claim 16, wherein the transfer function, H(z), of each filtering step is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where k₀ is a position value, k₁ is a depth value, α is a width value, and z is a delay coefficient.

21. A device for removing an interference signal, comprising:
a frequency tracking unit configured to track a frequency in a frequency domain for a signal with a different characteristic included in input signals to provide a first position value;
a power ratio calculation unit configured to calculate a power ratio of the first signal with a different characteristic and providing a first depth value set in correspondence with the calculated power ratio;
a first IIR notch filter configured to remove the first signal with a different characteristic based on the first position value and the first depth value; and
a second IIR notch filter configured to remove a second signal with a different characteristic included in the input signals based on a second position value and a second depth value,
wherein the frequency tracking unit provides the second IIR notch filter with the second position value obtained by adding a first predetermined value to the first position value, and the power ratio calculation unit provides the second IIR notch filter with the second depth value obtained by adding a second predetermined value to the first depth value.

22. The device according to claim 21, wherein the first predetermined value is a value corresponding to a frequency difference between the first signal with a different characteristic and the second signal with a different characteristic in the frequency domain, and the second predetermined value is a value corresponding to the power ratio of the first signal with a different characteristic and the second signal with a different characteristic.

23. The device according to claim 21, wherein the frequency tracking unit uses an ALE (Adaptive Line Enhancer) algorithm.

24. The device according to claim 21, wherein the power calculation unit provides the first IIR notch filter with the first depth value and the first width value set in correspondence with the calculated power ratio of the first signal with a different characteristic and provides the second IIR notch filter with the second depth value and the second width value obtained by respectively adding the second predetermined value to the first depth value and the first width value.

25. The device according to claim 21, wherein the transfer function, H(z), of each notch filter is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where k₀ is a position value, k₁ is a depth value, α is a width value, and z is a delay coefficient.

26. A method for removing an interference signal, comprising:
tracking a frequency in the frequency domain for a signal with a different characteristic included in input signals to acquire a first position value;
calculating a power ratio of the first signal with a different characteristic and acquiring a first depth value set in correspondence with the calculated power ratio;
removing the first signal with a different characteristic on the basis of the first position value and the first depth value; and
removing a second signal with a different characteristic included in the input signals using a second position value and a second depth value,
wherein the second position value is obtained by adding a first predetermined value to the first position value, and the second depth value is obtained by adding a second predetermined value to the first depth value.

27. The method according to claim 26, wherein the first predetermined value is a value corresponding to a frequency difference between the first signal with a different characteristic and the second signal with a different characteristic in the frequency domain, and the second predetermined value is a value corresponding to the power ratio of the first signal with a different characteristic and the second signal with a different characteristic.

28. The method according to claim 26, wherein the tracking operation uses an ALE (Adaptive Line Enhancer) algorithm.

29. The method according to claim 26, wherein the depth value acquisition step provides the first depth value and the first width value set in correspondence with the calculated power ratio of the first signal with a different characteristic, and provides the second depth value and the second width value respectively obtained by respectively adding the second predetermined value to the first depth value and the first width value to the second filtering step.

30. The method according to claim 26, wherein the transfer function, H(z), of each filtering step is defined as follows:
$$H ( z ) = \frac{1 + {k}_{0} ( 1 + {k}_{1} ) {z}^{- 1} + {k}_{1} {z}^{- 2}}{1 + {k}_{0} ( 1 + α {k}_{1} ) {z}^{- 1} + α {k}_{1} {z}^{- 2}}$$
where, k₀ is a position value, k₁ is a depth value, a is a width value, and z is a delay coefficient.
